(19) United States
(12) Patent Application Publication
(10) Pub. No.: US 2016/0073339 A1
(43) Pub. Date: Mar. 10, 2016

(54) Enhanced DCI Formats for Link Budget Improvement in LTE

(71) Applicant: Apple Inc., Cupertino, CA (US)

(72) Inventors: Tarik Tabet, Los Gatos, CA (US); Syed Aon Mujtaba, Santa Clara, CA (US); Awais M. Hussain, Milpitas, CA (US)

(21) Appl. No.: 14/823,409

(22) Filed: Aug. 11, 2015

Related U.S. Application Data
(60) Provisional application No. 62/046,855, filed on Sep. 5, 2014.

(51) Int. Cl. H04W 52/02; H04L 1/00; H04W 72/04; H04W 52/14

(52) U.S. Cl. CPC H04W 52/0209; H04W 52/143; H04L 1/0003; H04W 72/042

(57) ABSTRACT

In some embodiments, a user equipment device (UE) may be configured to transmit an indication to a base station that the UE is link budget limited and receive control information encoded in a downlink control information (DCI) format. The DCI format may be determined based on the indication. The UE may decode the control information according to the DCI format. The DCI format may specify the number of bits for various parameters and may combine these parameters. Parameters may include format flag, hopping flag, modulation and coding scheme (MCS), redundancy version (RV), uplink index, downlink assignment index (DAI), carrier indicator, channel state information (CSI) request, sounding reference symbol (SRS) request, resource allocation type, localized/distributed indication, code-word swap, and so forth. Additionally, the DCI format may specify a bit length when using a particular number of resource blocks.

This application claims benefit of priority to U.S. Provisional Application Serial No. 62/046,855, titled “Enhanced DCI Formats for Link Budget Improvement in LTE”, filed Sep. 5, 2014, by Tarik Tabet, Syed Aon Mujtaba, and Awais M. Hussain, which is hereby incorporated by reference in its entirety as though fully and completely set forth herein.

### FIELD

The present application relates to wireless communication, and more particularly, to mechanisms for increasing power savings of link budget user equipment (UE) devices via enhanced downlink control information (DCI) formats and/or the reduction of DCI formats used.

### DESCRIPTION OF THE RELATED ART

Wireless communication systems are rapidly growing in usage. Additionally, there exist numerous different wireless communication technologies and standards. Some examples of wireless communication standards include GSM, UMTS (WCDMA, TDS-CDMA), LTE, LTE Advanced (LTE-A), HSPA, 3GPP2 CDMA2000 (e.g., 1xRTT, 1xEV-DO, HRPD, eHRPD), IEEE 802.11 (WLAN or Wi-Fi), IEEE 802.16 (WiMAX), Bluetooth, etc.

In cellular radio access technologies (RATs) such as LTE, downlink control information (DCI) is used to carry information about uplink (UL) resource allocation and downlink (DL) assignment from a base station to a user equipment device (UE) or a group of UEs. In LTE, the DCI is carried by the physical downlink control channel (PDCCH) in the DL. The decoding performance of the PDCCH, and hence the power utilization for decoding the PDCCH, depend on the aggregation level, e.g., the number of control channel elements (CCE), and the payload size of, the DCI. A larger DCI payload will utilize a higher coding rate than a smaller DCI payload. Therefore, improvements in the field would be desirable.

### SUMMARY

Embodiments are presented herein of, inter alia, improved communication performance in a cellular communication system, and of devices configured to implement the methods.

Some embodiments relate to a user equipment device (UE) comprising at least one antenna, at least one radio, and one or more processors coupled to the radio. The at least one radio is configured to perform cellular communication using at least one radio access technology (RAT). The UE may be configured to perform voice and/or data communications, as well as the methods described herein.

In some embodiments, the UE may be configured to transmit an indication to a base station that the UE is link budget limited and receive control information encoded in a downlink control information (DCI) format. The DCI format may be determined based on the indication. The UE may decode the control information according to the DCI format.

In some embodiments, the UE may be configured to receive encoded control information from a base station, wherein the encoded control information is encoded using a DCI format.

Some embodiments relate to a base station configured to perform wireless communication with a wireless device. The base station includes a radio and a processing element operatively coupled to the radio. The base station may be configured to perform voice and/or data communications, as well as the method described herein.

In some embodiments, the base station may be configured to receive an indication that the UE is link budget limited and determine a DCI format based on the indication. The base station may encode control information using the determined DCI format to produce encoded control information and send the encoded control information to the UE.

In some embodiments, the base station may be configured to generate control information for transmission to the UE and encode the control information using a DCI format to produce encoded control information.

In any of the embodiments disclosed herein, the DCI format may specify the number of bits for various parameters and may combine these parameters. Parameters may include format flag, hopping flag, modulation and coding scheme (MCS), redundancy version (RV), uplink index, downlink assignment index (DAI), carrier indicator, channel state information (CSI) request, sounding reference symbol (SRS) request, resource allocation type, localized/distributed indication, code-word swap, and so forth. Additionally, the DCI format may specify a bit length when using a particular number of resource blocks.

Note that the techniques described herein may be implemented in and/or used with a number of different types of devices, including but not limited to, base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an exemplary wireless communication system, according to some embodiments.

FIG. 2 illustrates a base station (“BS”, or in the context of LTE, an “eNodeB” or “eNB”) in communication with a wireless device, according to some embodiments.

FIG. 3 illustrates a block diagram for one possible implementation of a wireless communication system, according to some embodiments.

FIG. 4 illustrates a block diagram for one possible embodiment of a base station, according to some embodiments.

FIG. 5A illustrates a method for improved communication performance in a cellular communication system, according to some embodiments.

FIG. 5B illustrates a processor including modules for improved communication performance in a cellular communication system, according to some embodiments.

FIG. 5C illustrates a method for improved communication performance in a cellular communication system, according to some embodiments.

FIG. 5D illustrates a processor including modules for improved communication performance in a cellular communication system, according to some embodiments.

FIG. 6 illustrates a DCI format 0-A as compared to prior art format 0, according to some embodiments.

FIG. 7 illustrates a DCI format 1A-1 as compared to prior art format 1A, according to some embodiments.

FIG. 8 illustrates a DCI format 1B-1 as compared to prior art format 1B, according to some embodiments.

FIG. 9 illustrates a DCI format 2-1 as compared to prior art format 2, according to some embodiments.

FIG. 10 illustrates prior art DCI format 1C.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. §112, paragraph six, interpretation for that component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system updates the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

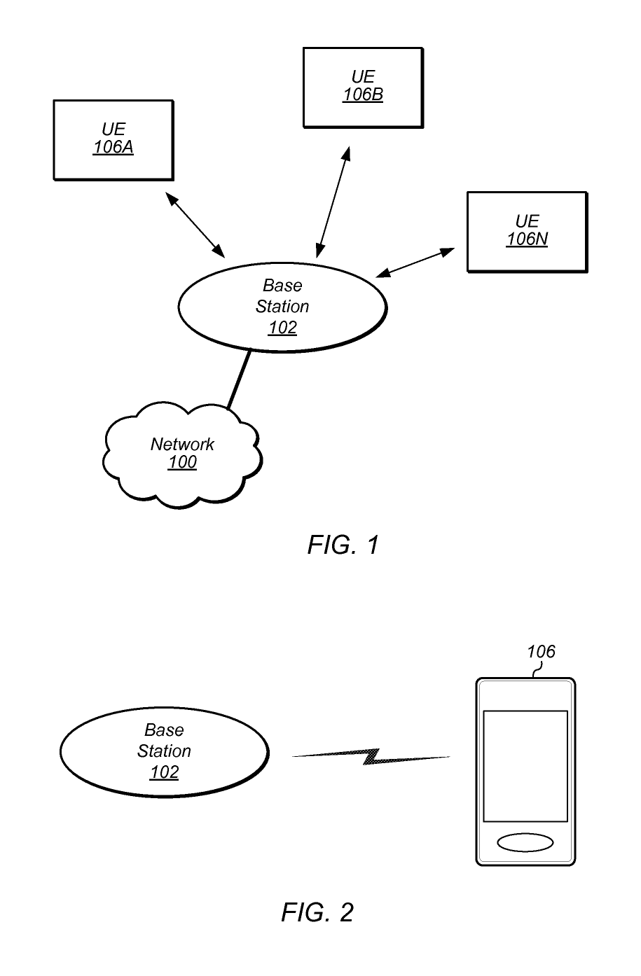

### FIG. 1—Wireless Communication System

FIG. 1 illustrates a wireless communication system, according to some embodiments. It is noted that FIG. 1 represents one possibility among many, and that features of the present disclosure may be implemented in any of various systems, as desired.

As shown, the exemplary wireless communication system includes a base station 102A which communicates over a transmission medium with one or more wireless devices 106A, 106B, etc., through 106N. Wireless devices may be user devices, which may be referred to herein as “user equipment” (UE) or UE devices.

The base station 102 may be a base transceiver station (BTS) or cell site, and may include hardware that enables wireless communication with the UE devices 106A through 106N. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication between the UE devices 106 and/or between the UE devices 106 and the network 100.

The communication area (or coverage area) of the base station 102 may be referred to as a “cell.” The base station 102 and the UEs 106 may be configured to communicate over the transmission medium using any of various radio access technologies (RATs) or wireless communication technologies, such as GSM, UMTS (WCDMA, TDS-CDMA), LTE, LTE-Advanced (LTE-A), HSPA, 3GPP2 CDMA2000 (e.g., 1xRTT, 1xEV-DO, HRPD, eHRPD), Wi-Fi, WiMAX etc.

Base station 102 and other similar base stations (not shown) operating according to one or more cellular communication technologies may thus be provided as a network of cells, which may provide continuous or nearly continuous overlapping service to UE devices 106A-N and similar devices over a wide geographic area via one or more cellular communication technologies.

Thus, while base station 102 may presently represent a “serving cell” for wireless devices 106A-N as illustrated in FIG. 1, each UE device 106 may also be capable of receiving signals from one or more other cells (e.g., cells provided by other base stations), which may be referred to as “neighboring cells”. Such cells may also be capable of facilitating communication between user devices and/or between user devices and the network 100.

Note that at least in some instances a UE device 106 may be capable of communicating using multiple wireless communication technologies. For example, a UE device 106 might be configured to communicate using two or more of GSM, UMTS, CDMA2000, WiMAX, LTE, LTE-A, WLAN, Bluetooth, one or more global navigational satellite systems (GNSS, e.g., GPS or GLONASS), one and/or more mobile television broadcasting standards (e.g., ATSC-M/H or DVB-H), etc. Other combinations of wireless communication technologies (including more than two wireless communication technologies) are also possible. Likewise, in some instances a UE device 106 may be configured to communicate using only a single wireless communication technology.

FIG. 2 illustrates UE device 106 (e.g., one of the devices 106A through 106N) in communication with base station 102. The UE device 106 may have cellular communication capability, and as described above, may be a device such as a mobile phone, a hand-held device, a media player, a computer, a laptop or a tablet, or virtually any type of wireless device.

The UE device 106 may include a processor that is configured to execute program instructions stored in memory. The UE device 106 may perform any of the method embodiments described herein by executing such stored instructions. Alternatively, or in addition, the UE device 106 may include a programmable hardware element such as an FPGA (field-programmable gate array) that is configured to perform any of the method embodiments described herein, or any portion of any of the method embodiments described herein.

In some embodiments, the UE device 106 may be configured to communicate using any of multiple radio access technologies and/or wireless communication protocols. For example, the UE device 106 may be configured to communicate using one or more of GSM, UMTS, CDMA2000, LTE, LTE-A, WLAN, Wi-Fi, WiMAX or GNSS. Other combinations of wireless communication technologies are also possible.

The UE device 106 may include one or more antennas for communicating using one or more wireless communication protocols or technologies. In some embodiments, the UE device 106 might be configured to communicate using a single shared radio. The shared radio may couple to a single antenna, or may couple to multiple antennas (e.g., for MIMO) for performing wireless communications. Alternatively, the UE device 106 may include two or more radios. For example, the UE 106 might include a shared radio for communicating using either of LTE or 1xRTT (or LTE or GSM), and separate radios for communicating using each of Wi-Fi and Bluetooth. Other configurations are also possible.

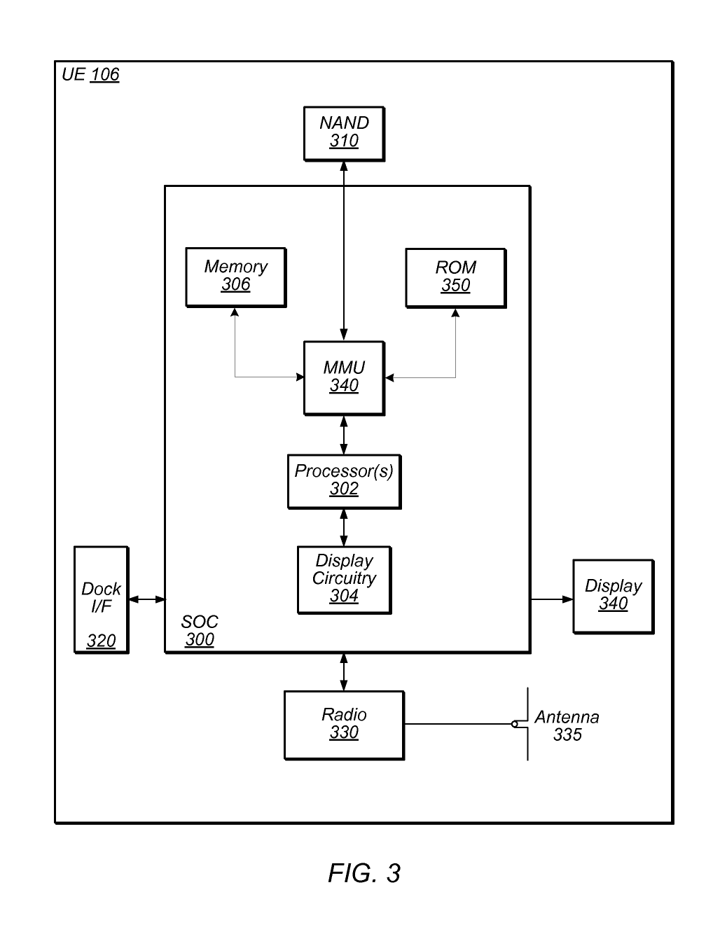

### FIG. 3—Example Block Diagram of a UE

FIG. 3 illustrates one possible block diagram of a UE 106. As shown, the UE 106 may include a system on chip (SOC) 300, which may include portions for various purposes. For example, as shown, the SOC 300 may include processor(s) 302 which may execute program instructions for the UE 106, and display circuitry 304 which may perform graphics processing and provide display signals to the display 340. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310). The MMU 340 may be configured to perform memory protection and page table translation or set up. In some embodiments, the MMU 340 may be included as a portion of the processor(s) 302.

The UE 106 may also include other circuits or devices, such as the display circuitry 304, radio 330, connector I/F 320, and/or display 340.

In the embodiment shown, ROM 350 may include a bootloader, which may be executed by the processor(s) 302 during boot up or initialization. As also shown, the SOC 300 may be coupled to various other circuits of the UE 106. For example, the UE 106 may include various types of memory (e.g., including NAND flash 310), a connector interface 320 (e.g., for coupling to a computer system), the display 340, and wireless communication circuitry (e.g., for communication using LTE, CDMA2000, Bluetooth, WiFi, GPS, etc.).

The UE device 106 may include at least one antenna, and in some embodiments multiple antennas, for performing wireless communication with base stations and/or other devices. For example, the UE device 106 may use antenna 335 to perform the wireless communication. As noted above, the UE may in some embodiments be configured to communicate wirelessly using a plurality of wireless communication standards.

As described herein, the UE 106 may include hardware and software components for implementing a method for responding to enhanced paging according to embodiments of this disclosure.

The processor 302 of the UE device 106 may be configured to implement part or all of the methods described herein, e.g., by executing program instructions stored on a memory medium (e.g., a non-transitory computer-readable memory medium). In other embodiments, processor 302 may be configured as a programmable hardware element, such as an FPGA (Field Programmable Gate Array), or as an ASIC (Application Specific Integrated Circuit).

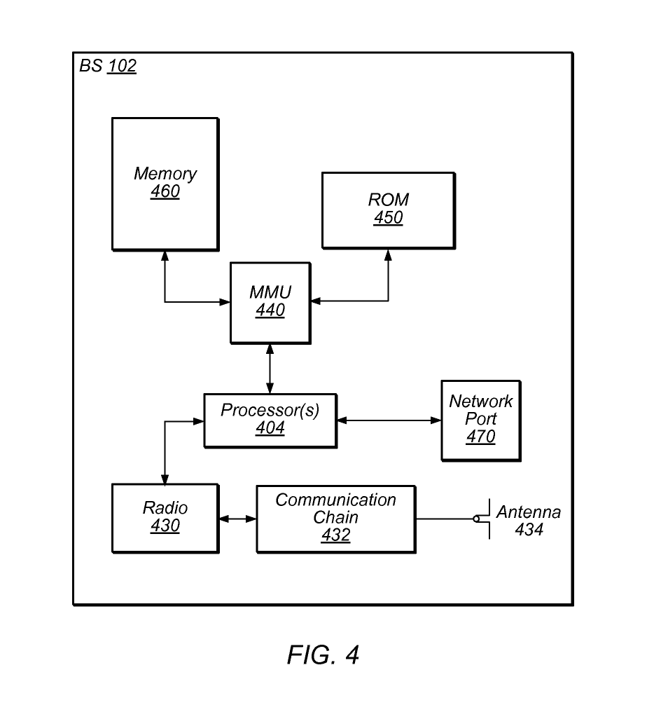

### FIG. 4—Base Station

FIG. 4 illustrates a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include a radio 430, a communication chain 432 and at least one antenna 434. The base station may be configured to operate as a wireless transceiver and may be further configured to communicate with UE devices 106 via radio 430, communication chain 432 and the at least one antenna 434. Communication chain 432 may be a receive chain, a transmit chain or both. The radio 430 may be configured to communicate via various RATs, including, but not limited to, GSM, UMTS, LTE, WCDMA, CDMA2000, WiMAX, etc.

The processor(s) 404 of the base station 102 may be configured to implement part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof.

### Limiting DCI Payload Size and Formats Used

### DCI Background

Ten DCI formats are used in LTE release 8 and LTE release 10 added an additional 3 formats. For example, DCI format 0 is used for UL grant and resource allocation for UL data. Format 1 is used for DL allocation of resources for UEs using single input multiple output (SIMO). Format 1A is used for DL allocation of resources for SIMO operation and is a compact version of format 1. Format 1B is used for transmitting control information for multiple input multiple output (MIMO) rank 1. Format 1C is used for compact transmission of physical downlink shared channel (PDSCH) assignment and contains the minimum information for assignment. Format 1D is used for DL assignment for multi user multiple input multiple output (MIMO). Formats 2 and 2A are used for transmission of DL shared channel (DL-SCH) allocation for closed (format 2) and open (format 2A) loop MIMO operation. Format 2B is used for DL assignment for transmission mode 8 dual layer beam-forming and format 2C is used for DL assignment for transmission mode 9. Format 3 is used for transmission of transmit power control (TPC) commands for the physical uplink control channel (PUCCH) and the physical uplink shared channel (PUSCH) with a 2 bit power adjustment. Format 3A is used for TPC command for PUCCH and PUSCH with a 1 bit power adjustment. Format 4 is used for UL assignment for UL MIMO with up to 4 layers.

For devices that are link budget limited, it is important to improve the SINR for PDCCH to improve decoding. Note that a link budget limited device may be, for example, a UE that is power limited or in a power conservation state, or if it is equipped with a poorly performing antenna system and/or if the UE is located in area of poor coverage (e.g., in the basement of a building). Thus, the UE may be temporarily, or currently, link budget limited. In each case, since power is limited, reducing the payload size of the DCI and/or limiting the number of DCI formats (e.g., simplifying DCI decoding) may improve PDCCH decoding performance.

Thus, in some embodiments, a link budget limited device, e.g., a range constrained and/or a power limited UE, may not support all possible transmission modes of LTE. For example, in some embodiments, the link budget limited device may only include a single antenna and therefore, may not support MIMO. Alternatively, the link budget limited device may include additional antennae but may be operating in a reduced power state or may be operating at a range such that the device may not be able to support MIMO. For example, the link budget limited device may be operating at a cell edge and may not have enough transmission power available to perform MIMO communications.

Therefore, in some embodiments, since the link budget limited device may not be supporting all transmission modes, the DCI decoding may be simplified by using only DCI formats supported by the transmission modes available to the link budget limited device. For example, only DCI formats 0, 1A, 1C, and 2 may be available for a link budget limited device not currently supporting MIMO. DCI format 0 may be utilized because it is used for the UL grant. Additionally, DCI format 1A may be utilized because it is mainly used for transmit diversity with cell radio network temporary identifier (C-RNTI) (e.g., dedicated data) and for paging, system information block (SIB) information and random access channel (RACH) procedure (e.g., control information with paging RNTI (P-RNTI), system information RNTI (SI-RNTI), and random access RNTI (RA-RNTI)). In some embodiments, the use of DCI format 1A may be limited and paging may be performed using the more compact, e.g., smaller payload, DCI format 1C, which is mainly used for paging, SIB information and RACH procedure.

Further, format DCI 2 may be available because it is used for single code-word transmission mode 4 (no MIMO). However, in embodiments in which the link budget limited device only supports one code-word, DCI format 1B may be used since it indicates transmission mode 6 which is equivalent to transmission mode 4 with rank 1 for devices supporting only one code-word.

Further, as described below in detail, in some embodiments, DCI formats 0, 1A, 1B and 2 may be modified to reduce the payload of the DCI bitmap in order to lower the coding rate and improve the performance of the PDCCH.

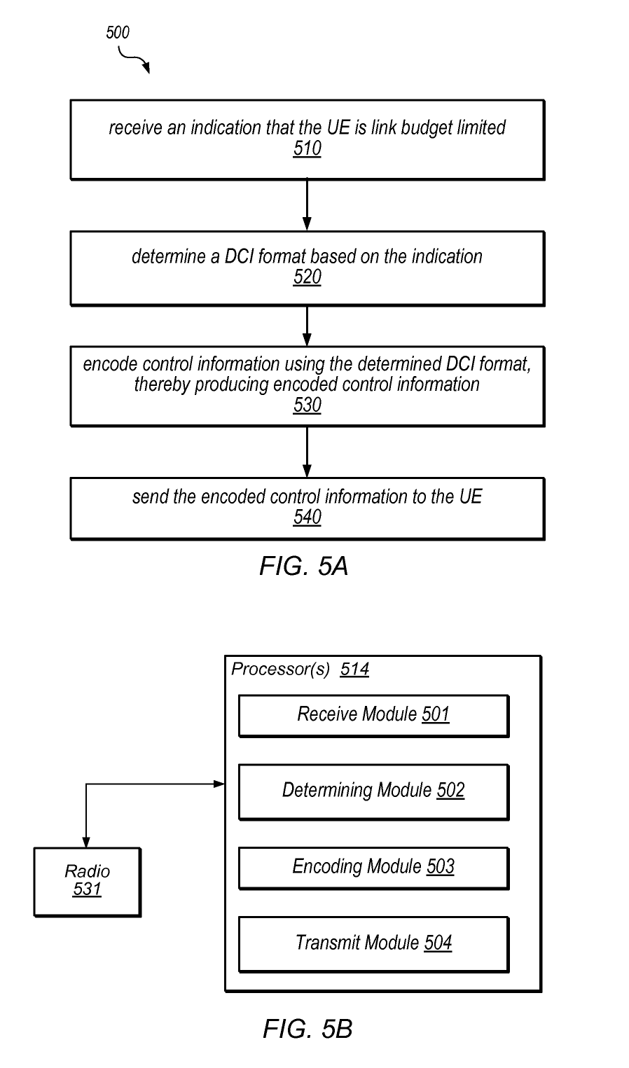

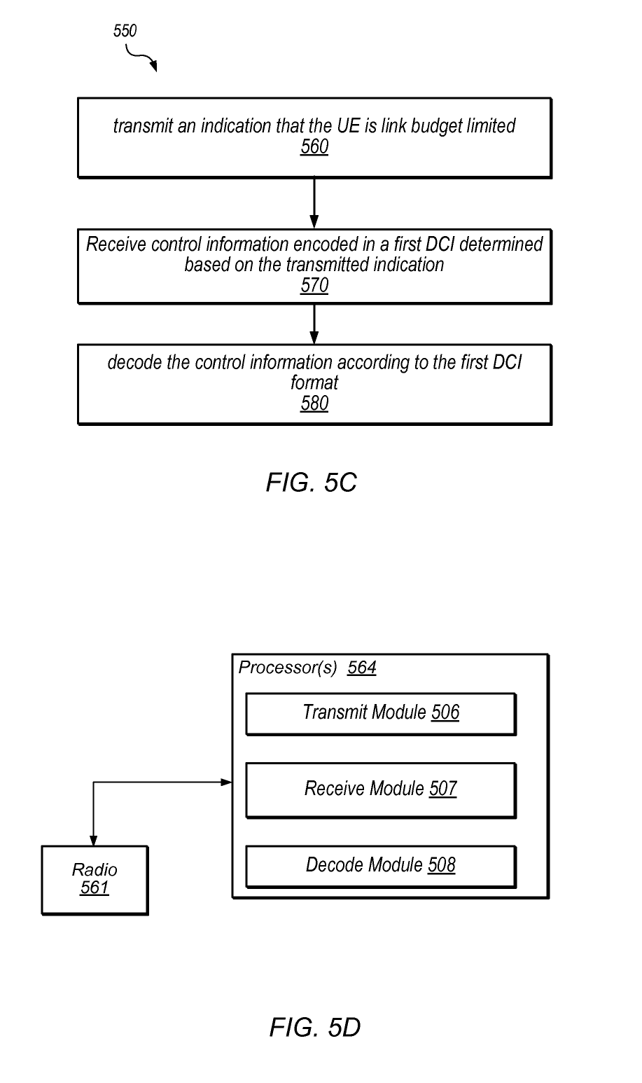

### FIGS. 5A-5D: Method for Improved Communication Performance in a Cellular Communication System

FIG. 5A illustrates a method 500 for improved communication performance in a cellular communication system, according to some embodiments. The method shown in FIG. 5A may be used in conjunction with any of the systems or devices shown in the above Figures, among other devices. In various embodiments, some of the method elements shown may be performed concurrently, in a different order than shown, or may be omitted. Additional method elements may also be performed as desired. As shown, method 500 may operate as follows.

At 510, an indication that the UE is a link budget limited device may be received. The indication may be received via radio resource control (RRC) signaling. Note that a link budget limited device may be, for example, a UE that is power limited (e.g., transmission power is capped at a value that is less than the UE may have available at other instances) and/or in a power conservation state (e.g., conserving power of a battery), or if it is equipped with a poorly performing antenna system and/or if the UE is located in area of poor coverage (e.g., in the basement of a building).

At 520, a DCI format may be determined based on the indication. In other words, the selection of the DCI format may be based on the condition of the UE. In some embodiments, the DCI format may be one of a plurality of possible DCI formats. In such embodiments, the DCI format may be selected because it is the smallest DCI format, in terms of payload size, that supports the transmission mode used for communications between the UE and the base station. Alternatively, the DCI format may be selected because it is the smallest DCI format, in terms of payload size, that supports an equivalent transmission mode that is used for communications between the UE and the base station.

At 530, the control information may be encoded to produce encoded control information using the determined DCI format. In some embodiments, the DCI format may specify a combination of 0 bits for format flag, 0 bits for a hopping flag, 4 bits for modulation and coding scheme (MCS) and redundancy version (RV), 0 bits for uplink index, or 0 bits for downlink assignment index (DAI). In various embodiments, the DCI format may specify a combination of 2 or more, 3 or more, 4 or more, and so forth of the listed DCI fields. In certain embodiments, the DCI format may further specify a combination of 0 bits for carrier indicator, 1 bit for CSI request, 0 bits for SRS request, or 0 bits for resource allocation type. In some embodiments, the DCI format may be an alternative for DCI format 0 as specified in Section 5.3.3.1.1 of 3GPP TS 36.212 version 10.8.0. In certain embodiments, the DCI format may specify a combination of 2 or more, 3 or more, 4 or more, and so forth of the listed DCI fields.

In some embodiments the DCI format may specify a combination of 0 bits for format flag, 0 bits for localized/distributed indication, 4 bits for MCS, or 0 bits for downlink assignment index (DAI). In various embodiments, the DCI format may specify a combination of 2 or more, 3 or more, 4 or more, and so forth of the listed DCI fields. In some embodiments, the DCI format may be an alternative for DCI format 1A as specified in Section 5.3.3.1.3 of 3GPP TS 36.212 version 10.8.0.

In some embodiments the DCI format may specify a combination of 0 bits for localized/distributed indication and 4 bits for MCS. In some embodiments, the DCI format may be an alternative for DCI format 1B as specified in Section 5.3.3.1.3A of 3GPP TS 36.212 version 10.8.0.

In some embodiments the DCI format may specify a combination of 0 bits for resource allocation (RA) header, 0 bits for code-word swap, 4 bits for a first MCS for a first code-word, 0 bits for a second modulation MCS for a second code-word, 0 bits for a new data index (NDI) for the second code-word, 0 bits for a RV for the second code-word, or 0 bits for DAI. In various embodiments, the DCI format may specify a combination of 2 or more, 3 or more, 4 or more, and so forth of the listed DCI fields. In some embodiments, the DCI format may be an alternative for DCI format 2 as specified in Section 5.3.3.1.5 of 3GPP TS 36.212 version 10.8.0.

In some embodiments the DCI format may specify one or more of a 24 bit length total when using 100 resource blocks, a 23 bit length total when using 75 resource blocks, a 22 bit length total when using 50 resource blocks, a 20 bit length total when using 25 resource blocks, a 18 bit length total when using 15 resource blocks, or a 16 bit length total when using 6 resource blocks.

In some embodiments the DCI format may specify one or more a 25 bit length total when using 100 resource blocks, a 24 bit length total when using 75 resource blocks, a 23 bit length total when using 50 resource blocks, a 21 bit length total when using 25 resource blocks, a 19 bit length total when using 15 resource blocks, or a 17 bit length total when using 6 resource blocks.

In some embodiments the DCI format may specify one or more a 30 bit length total when using 100 resource blocks, a 29 bit length total when using 75 resource blocks, a 28 bit length total when using 50 resource blocks, a 26 bit length total when using 25 resource blocks, a 24 bit length total when using 15 resource blocks, or a 22 bit length total when using 6 resource blocks.

In some embodiments the DCI format may specify one or more a 41 bit length total when using 25 resource blocks, a 35 bit length total when using 125 resource blocks, a 33 bit length total when using 115 resource blocks, a 31 bit length total when using 100 resource blocks, a 26 bit length total when using 8 resource blocks, or a 24 bit length total when using 6 resource blocks.

At 540, the encoded control information may be sent to the UE. In some embodiments, the encoded control information may be sent on the PDCCH.

FIG. 5B illustrates a processor including modules for improved communication performance in a cellular communication system, according to some embodiments. In some embodiments, radio 531 (which may be equivalent to radio 430 described above) may be coupled to processor 514 (which may be equivalent to processor(s) 404 described above. The processor may be configured to perform the method described above in reference to FIG. 5A. In some embodiments, processor 514 may include one or more modules, such as modules 501-504, and the modules may be configured to perform various steps of the method described above in reference to FIG. 5A. As shown, the modules may be configured as follows.

In some embodiments, processor 514 may include a receive module 501 configured to receive an indication that a UE is a link budget limited device. The indication may be received via radio resource control (RRC) signaling. Note that a link budget limited device may be, for example, a UE that is power limited (e.g., transmission power is capped at a value that is less than the UE may have available at other instances) and/or in a power conservation state (e.g., conserving power of a battery), or if it is equipped with a poorly performing antenna system and/or if the UE is located in area of poor coverage (e.g., in the basement of a building).

In addition, processor 514 may include a determining module 502 configured to determine a DCI format based on the indication. In other words, the selection of the DCI format may be based on the condition of the UE. In some embodiments, the DCI format may be one of a plurality of possible DCI formats. In such embodiments, the DCI format may be selected because it is the smallest DCI format, in terms of payload size, that supports the transmission mode used for communications between the UE and the base station. Alternatively, the DCI format may be selected because it is the smallest DCI format, in terms of payload size, that supports an equivalent transmission mode that is used for communications between the UE and the base station.

Further, processor 514 may include an encoding module 503 configured to encode the control information to produce encoded control information using the determined DCI format.

Additionally, processor 514 may include a transmit module 504 configured to transmit the encoded control information to the UE. In some embodiments, the encoded control information may be sent on the PDCCH.

It is apparent for those skilled in the art that, for the particular processes of the modules described above (such as modules 501, 502, 503, and 504), reference may be made to the corresponding steps (such as steps 510, 520, 530, and 540, respectively) in the related process embodiment sharing the same concept and the reference is regarded as the disclosure of the related modules as well. Furthermore, processor 514 may be implemented in software, hardware or combination thereof. More specifically, processor 514 may be implemented as a processing element, which includes, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors. Additionally, processor 514 may be implemented as a general-purpose processor such as a CPU, and therefore each module can be implemented with the CPU executing instructions stored in a memory which perform a respective step.

FIG. 5C illustrates a method 550 for improved communication performance in a cellular communication system, according to some embodiments. The method shown in FIG. 5C may be used in conjunction with any of the systems or devices shown in the above Figures, among other devices. In various embodiments, some of the method elements shown may be performed concurrently, in a different order than shown, or may be omitted. Additional method elements may also be performed as desired. As shown, method 500 may operate as follows.

At 560, an indication that the UE is a link budget limited device may be transmitted. The indication may be transmitted via radio resource control (RRC) signaling. Note that a link budget limited device may be, for example, a UE that is power limited (e.g., transmission power is capped at a value that is less than the UE may have available at other instances) and/or in a power conservation state (e.g., conserving power of a battery), or if it is equipped with a poorly performing antenna system and/or if the UE is located in area of poor coverage (e.g., in the basement of a building).

At 570, encoded control information may be received by the UE. In some embodiments, the encoded control information may be received on the PDCCH. The control information may be encoded in a DCI format that may be determined based on the indication. In other words, the selection of the DCI format may be based on the condition of the UE. In some embodiments, the DCI format may be one of a plurality of possible DCI formats. In such embodiments, the DCI format may be selected because it is the smallest DCI format, in terms of payload size, that supports the transmission mode used for communications between the UE and a base station. Alternatively, the DCI format may be selected because it is the smallest DCI format, in terms of payload size, that supports an equivalent transmission mode that is used for communications between the UE and the base station.

In some embodiments, the control information may be encoded to produce encoded control information using the determined DCI format. In some embodiments, the DCI format may specify a combination of 0 bits for format flag, 0 bits for a hopping flag, 4 bits for modulation and coding scheme (MCS) and redundancy version (RV), 0 bits for uplink index, or 0 bits for downlink assignment index (DAI). In various embodiments, the DCI format may specify a combination of 2 or more, 3 or more, 4 or more, and so forth of the listed DCI fields. In certain embodiments, the DCI format may further specify a combination of 0 bits for carrier indicator, 1 bit for CSI request, 0 bits for SRS request, or 0 bits for resource allocation type. In some embodiments, the DCI format may be an alternative for DCI format 0 as specified in Section 5.3.3.1.1 of 3GPP TS 36.212 version 10.8.0. In certain embodiments, the DCI format may specify a combination of 2 or more, 3 or more, 4 or more, and so forth of the listed DCI fields.

In some embodiments the DCI format may specify a combination of 0 bits for format flag, 0 bits for localized/distributed indication, 4 bits for MCS, or 0 bits for downlink assignment index (DAI). In various embodiments, the DCI format may specify a combination of 2 or more, 3 or more, 4 or more, and so forth of the listed DCI fields. In some embodiments, the DCI format may be an alternative for DCI format 1A as specified in Section 5.3.3.1.3 of 3GPP TS 36.212 version 10.8.0.

In some embodiments the DCI format may specify a combination of 0 bits for localized/distributed indication and 4 bits for MCS. In some embodiments, the DCI format may be an alternative for DCI format 1B as specified in Section 5.3.3.1.3A of 3GPP TS 36.212 version 10.8.0.

In some embodiments the DCI format may specify a combination of 0 bits for resource allocation (RA) header, 0 bits for code-word swap, 4 bits for a first MCS for a first code-word, 0 bits for a second modulation MCS for a second code-word, 0 bits for a new data index (NDI) for the second code-word, 0 bits for a RV for the second code-word, or 0 bits for DAI. In various embodiments, the DCI format may specify a combination of 2 or more, 3 or more, 4 or more, and so forth of the listed DCI fields. In some embodiments, the DCI format may be an alternative for DCI format 2 as specified in Section 5.3.3.1.5 of 3GPP TS 36.212 version 10.8.0.

In some embodiments the DCI format may specify one or more of a 24 bit length total when using 100 resource blocks, a 23 bit length total when using 75 resource blocks, a 22 bit length total when using 50 resource blocks, a 20 bit length total when using 25 resource blocks, a 18 bit length total when using 15 resource blocks, or a 16 bit length total when using 6 resource blocks.

In some embodiments the DCI format may specify one or more a 25 bit length total when using 100 resource blocks, a 24 bit length total when using 75 resource blocks, a 23 bit length total when using 50 resource blocks, a 21 bit length total when using 25 resource blocks, a 19 bit length total when using 15 resource blocks, or a 17 bit length total when using 6 resource blocks.

In some embodiments the DCI format may specify one or more a 30 bit length total when using 100 resource blocks, a 29 bit length total when using 75 resource blocks, a 28 bit length total when using 50 resource blocks, a 26 bit length total when using 25 resource blocks, a 24 bit length total when using 15 resource blocks, or a 22 bit length total when using 6 resource blocks.

In some embodiments the DCI format may specify one or more a 41 bit length total when using 25 resource blocks, a 35 bit length total when using 125 resource blocks, a 33 bit length total when using 115 resource blocks, a 31 bit length total when using 100 resource blocks, a 26 bit length total when using 8 resource blocks, or a 24 bit length total when using 6 resource blocks.

At 580, the encoded control information may be decoded by the UE according to the determined DCI format.

FIG. 5D illustrates a processor including modules for improved communication performance in a cellular communication system, according to some embodiments. In some embodiments, radio 561 (which may be equivalent to radio 330 described above) may be coupled to processor 564 (which may be equivalent to processor(s) 302 described above. The processor may be configured to perform the method described above in reference to FIG. 5C. In some embodiments, processor 564 may include one or more modules, such as modules 506-508, and the modules may be configured to perform various steps of the method described above in reference to FIG. 5C. As shown, the modules may be configured as follows.

In some embodiments, processor 564 may include a transmit module 506 configured to transmit an indication that the UE is a link budget limited device. The indication may be transmitted via radio resource control (RRC) signaling. Note that a link budget limited device may be, for example, a UE that is power limited (e.g., transmission power is capped at a value that is less than the UE may have available at other instances) and/or in a power conservation state (e.g., conserving power of a battery), or if it is equipped with a poorly performing antenna system and/or if the UE is located in area of poor coverage (e.g., in the basement of a building).

Additionally, processor 564 may include a receive module 507 configured to receive encoded control information. In some embodiments, the encoded control information may be received on the PDCCH. The control information may be encoded in a DCI format that may be determined based on the indication. In other words, the selection of the DCI format may be based on the condition of the UE. In some embodiments, the DCI format may be one of a plurality of possible DCI formats. In such embodiments, the DCI format may be selected because it is the smallest DCI format, in terms of payload size, that supports the transmission mode used for communications between the UE and a base station. Alternatively, the DCI format may be selected because it is the smallest DCI format, in terms of payload size, that supports an equivalent transmission mode that is used for communications between the UE and the base station. In some embodiments, the control information may be encoded to produce encoded control information using the determined DCI format.

Further, processor 564 may include a decode module 508 configured to decode the encoded control information according to the determined DCI format.

It is apparent for those skilled in the art that, for the particular processes of the modules described above (such as modules 506, 507, and 508), reference may be made to the corresponding steps (such as steps 560, 570, and 580, respectively) in the related process embodiment sharing the same concept and the reference is regarded as the disclosure of the related modules as well. Furthermore, processor 564 may be implemented in software, hardware or combination thereof. More specifically, processor 564 may be implemented as a processing element, which includes, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors. Additionally, processor 564 may be implemented as a general-purpose processor such as a CPU, and therefore each module can be implemented with the CPU executing instructions stored in a memory which perform a respective step.

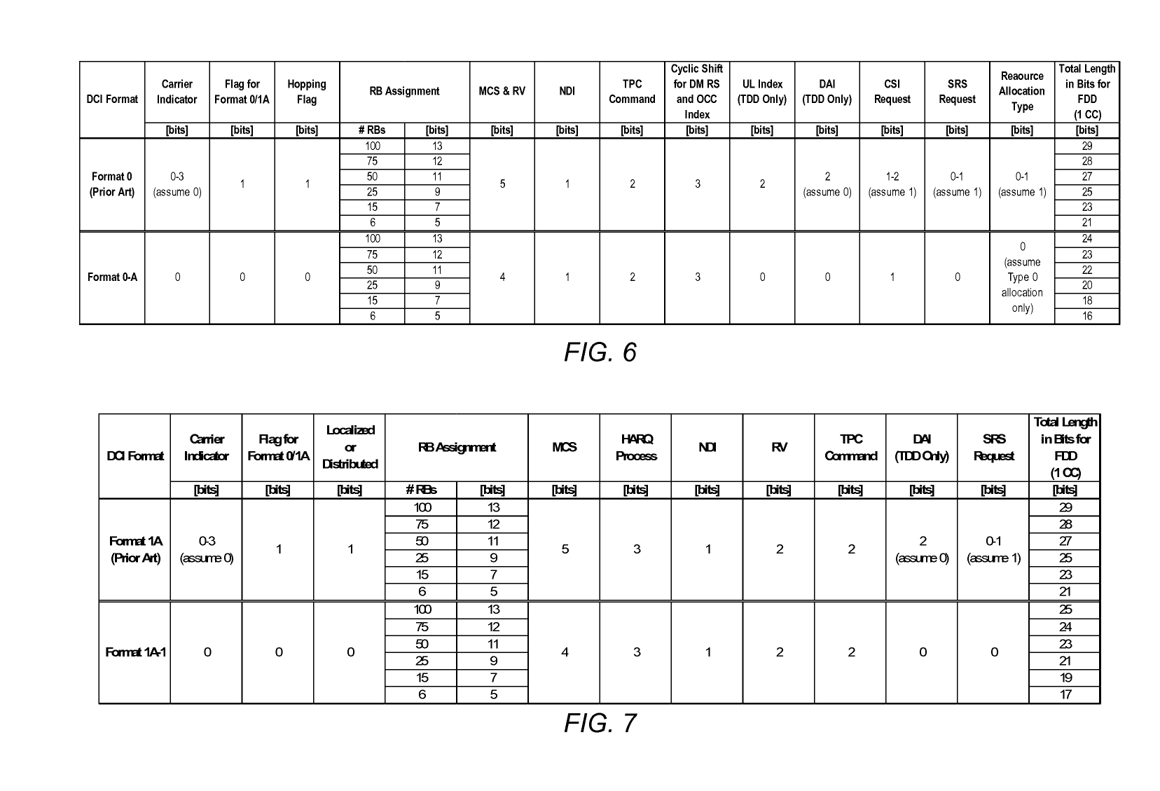

### FIGS. 6-10: DCI Formats

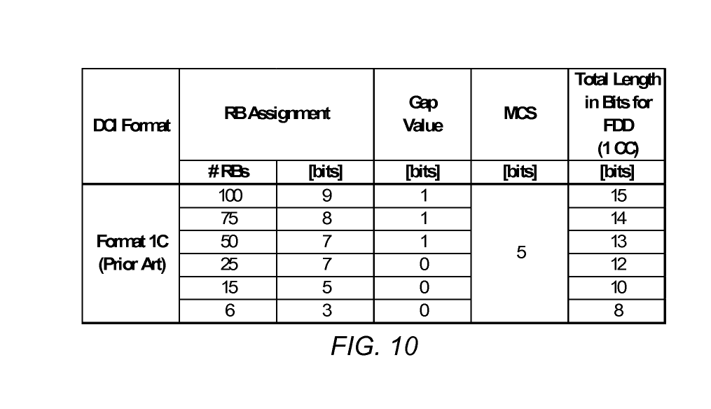

FIGS. 6-10 illustrate current and proposed downlink control information (DCI) formats for transmission on the physical downlink control channel (PDCCH) in the DL. Each of FIGS. 6-9 illustrates payload savings for various parameters included in the DCI for a particular format as compared to the prior art format. FIG. 10 illustrates the prior art format 1C, which may be preferred in some embodiments. Note that the figures are representative only and are illustrative of possible implementations of the methods and devices described above. Thus, for example although the figures show detailed configurations for DCI formats, the configurations are exemplary only and various combinations may be employed to generate other configurations as desired.

FIG. 6 illustrates a possible implementation to reduce the DCI payload as compared to prior art DCI format 0 as specified in Section 5.3.3.1.1 of 3GPP TS 36.212 version 10.8.0, according to some embodiments. As shown, DCI format 0 includes a carrier indicator field utilizing 0 to 3 bits of data. The carrier indicator field, introduced in LTE release 10, indicates on which carrier the scheduled resource is located for UEs using carrier aggregation. For backward compatibility, the field may be omitted for UEs not using carrier aggregation. The flag for format 0/1A field indicates to the UE whether format 0 or 1A is being used and utilizes 1 bit of data. Note that the flag is used because format 0 and 1A are the same size. The hopping flag indicates to the UE whether frequency hopping is being used and utilizes 1 bit of data. The resource block assignment indicates to the UE the number of resource blocks to be used. The bits utilized are based on the number of resource blocks and range, as shown, from 5 to 13 bits. The modulation and coding scheme (MCS) and redundancy version (RV) utilize a combined 5 bits. The new data indicator (NDI) field utilizes 1 bit and the TPC command utilizes 2 bits. The cyclic shift for demodulation reference signal (DM RS) and orthogonal cover code (OCC) index utilize 3 bits. For time division duplexing (TDD) only, the UL index and DL assignment index (DIA) each utilizes 2 bits. However, the DIA index is optional, thus, may utilize zero bits. The channel state information (CSI) request utilizes 1 to 2 bits and the sounding reference signal (SRS) request field utilizes 0-1 bit. Similarly, the resource allocation type utilizes 0-1 bits. Thus, assuming the carrier indicator and DAI do not utilize any bits and the CSI request, the SRS request, and the resource allocation type fields each utilizes 1 bit, the payload for the DCI format 0 bitmap will range between 21 and 29 bits depending upon the number of resource blocks used.

In contrast to the DCI format 0 bitmap, the DCI format 0-A bitmap may have a payload ranging between 16 and 24 bits. This may be accomplished via the elimination of certain fields. For example, by changing the payload size (or bit length) of the format, collisions with DCI format 0 and 1A may be avoided and may allow for the removal of the flag for format 0/1A field, thus saving 1 bit. Since the link budget limited device may be currently supporting only a single antenna, the carrier indicator field may also be removed resulting in the savings of 0 to 3 bits. Additionally, the link budget limited device may not be currently supporting UL frequency hopping, therefore the hopping flag field may be omitted, saving an additional bit. Further, by not currently supporting 64-QAM (quadrature amplitude modulation), another bit may be saved in the MCS and RV field. Additionally, the link budget limited device may be currently only supporting frequency division duplexing (FDD), therefore fields related to TDD (UL Index and DAI) may be omitted, saving an additional 4 bits. In addition, the link budget limited device may not currently be supporting coordinated multi-point transmission/reception (CoMP) or utilize frequency scheduling (SRS request). Thus, a bit may be saved in each of the CSI request and SRS request fields. Finally, the resource allocation type may be type 0, therefore the resource allocation type field may be omitted saving another bit. In total, the DCI format 0-A may save 5 bits as compared to prior art DCI format 0. The savings of bits in the payload of the DCI format may improve the SINR of the PDCCH.

FIG. 7 illustrates a possible implementation to reduce the DCI payload as compared to prior art DCI format 1A as specified in Section 5.3.3.1.3 of 3GPP TS 36.212 version 10.8., according to some embodiments. As shown, DCI format 1A includes a carrier indicator field utilizing 0 to 3 bits of data. Similar to DCI format 0, the flag for format 0/1A field indicates to the UE whether format 0 or 1A is being used and utilizes 1 bit of data. Further, the localized or distributed field indicates to the UE the transmission type and also utilizes 1 bit. As with DCI format 0, the resource block assignment indicates to the UE the number of resource blocks to be used and utilizes between 5 and 13 bits. The MCS field utilizes 5 bits, the RV field utilizes 2 bits, the NDI field utilizes 1 bit, the TPC command utilizes 2 bits, and the SRS request field utilizes 0 to 1 bit. For TDD only, the DIA index utilizes 2 bits. Further, the SRS request field utilizes 0 to 1 bit. Similarly, the resource allocation type utilizes 0 to 1 bit. Thus, assuming the carrier indicator and DAI do not utilize any bits and the SRS request utilizes 1 bit, the payload for the DCI format 1A bitmap will range between 21-29 bits depending upon the number of resource blocks used.

In contrast to the DCI format 1A bitmap, the DCI format 1A-1 bitmap may have a payload ranging between 17 and 25 bits. This may be accomplished via the elimination of certain fields, similar to DCI format 0-A. Thus, for example, by changing the payload size (or bit length) of the format, collisions with DCI format 0, 0-A and 1A may be avoided and may allow for the removal of the flag for format 0/1A field, thus saving 1 bit. Further, since the link budget limited device may be currently supporting only a single antenna, the carrier indicator field may also be removed resulting in the savings of 0 to 3 bits. Additionally, the link budget limited device may only support localized transmission type, and, therefore, the localized/distributed field may be omitted saving an additional bit. Furthermore, the link budget limited device may be currently only supporting FDD, therefore DAI field may be omitted, saving an additional 2 bits. In addition, the link budget limited device may not currently utilize frequency scheduling (SRS request), thus, a bit may be saved in the SRS request field. In total, the DCI format 1A-1 may save 4 bits as compared to prior art DCI format 1A.

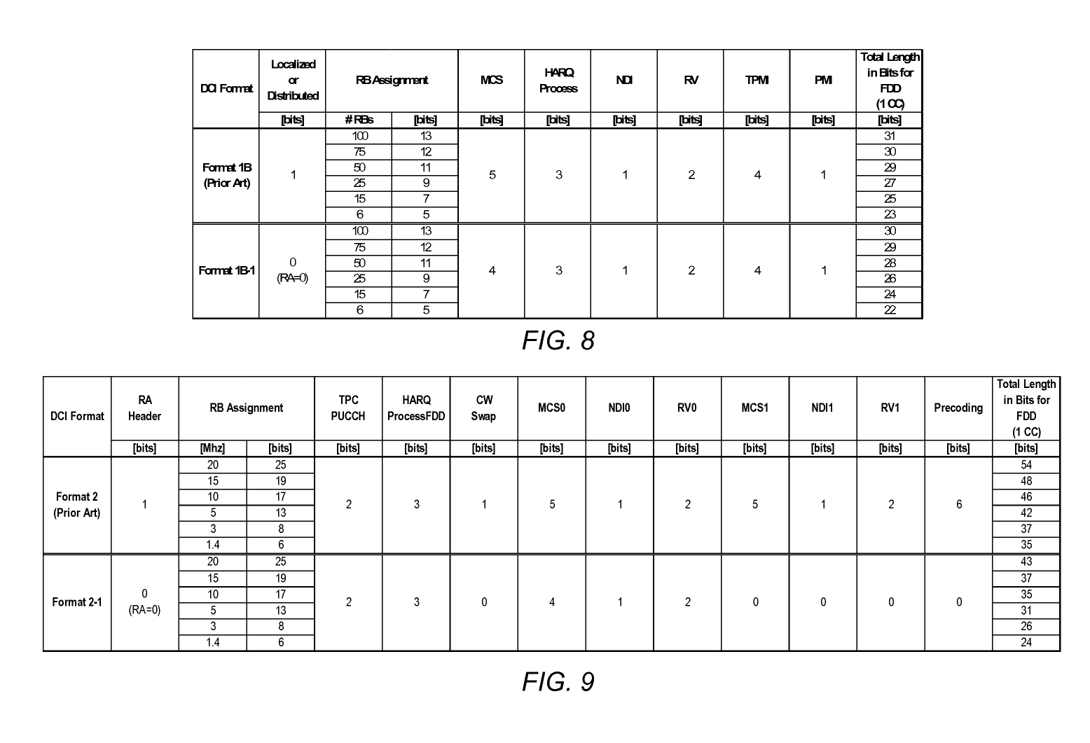

FIG. 8 illustrates a possible implementation to reduce the DCI payload as compared to prior art DCI format 1B as specified in Section 5.3.3.1.3A of 3GPP TS 36.212 version 10.8.0, according to some embodiments. As shown, DCI format 1B includes a localized or distributed field utilizing 1 bit. As with DCI formats 0 and 1A, the resource block assignment utilizes between 5 and 13 bits. The MCS field utilizes 5 bits, the RV field utilizes 2 bits, and the NDI field utilizes 1 bit. The hybrid automatic repeat request (HARM) process field utilizes 3 bits. The transmitted pre-coding matrix indicator (TPMI) utilizes 4 bits and the pre-coding matrix indicator (PMI) utilizes 1 bit. Thus, the payload for the DCI format 1B bitmap will range between 23 and 31 bits depending upon the number of resource blocks used.

In contrast to the DCI format 1B bitmap, the DCI format 1B-1 bitmap may have a payload ranging between 22 and 30 bits. This may be accomplished via the elimination of the localized/distributed field as discussed above in reference to DCI format 1A-1. The remaining fields may all be used by the link budget limited device, therefore DCI format 1B-1 may save 1 bit as compared to prior art DCI format 1B.

FIG. 9 illustrates a possible implementation to reduce the DCI payload as compared to prior art DCI format 2 as specified in Section 5.3.3.1.5 of 3GPP TS 36.212 version 10.8.0, according to some embodiments. As shown, DCI format 2 includes a resource allocation (RA) header field utilizing 1 bit. Unlike DCI formats 0, 1A and 1B, the resource block assignment utilizes between 6 and 25 bits for DCI format 2 in the increments as shown. The transmit power control (TPC) physical uplink control channel (PUCCH) field utilizes 2 bits and the HARQ process field for frequency division duplexing (FDD) utilizes 3 bits. The code-word swap field utilizes 1 bit. The MCW field for each code-word (MCSO and MCS1) each utilizes 5 bits, the NDI field for each code-word (NDIO and NDI1) each utilizes 1 bit, and the RV for each code-word (RVO and RV1) each utilizes 2 bits. Additionally, the pre-coding field utilizes 6 bits. Thus, the payload for the DCI format 2 bitmap will range between 35 and 54 bits depending upon the number of resource blocks used.

In contrast to the DCI format 2 bitmap, the DCI format 2-1 bitmap may have a payload ranging between 24 and 43 bits. This may be accomplished via the elimination of fields related to the second code-word available in DCI format 2. First, since the RA header field may be omitted since the resource allocation will be type 0 for the link budget limited device. Additionally, since the link budget limited device may be currently supporting only one code-word, the CW swap field, along with the MCS1, NDI1, and RV1 fields may be omitted. Further, by not currently supporting 64-QAM (quadrature amplitude modulation), another bit may be saved in the MCSO field. Thus, in total, the DCI format 2-1 may save 11 bits as compared to prior art DCI format 2.

FIG. 10 illustrates prior art DCI format 1C that may be used in conjunction with implementations of some embodiments. As noted above, DCI format 1C as specified in Section 5.3.3.1.4 of 3GPP TS 36.212 version 10.8.0 is a compact version of DCI format 1A. As shown, DCI format 1C, like DCI format 1A includes the resource block assignment that utilizes between 3 and 9 bits. The MCS field utilizes 5 bits and the gap value indicator utilizes 1 bit for certain resource block assignments. Thus, the payload for the DCI format 1C bitmap will range between 8 and 15 bits depending upon the number of resource blocks used.

### Further Embodiments

In some embodiments, a base station may be configured to perform wireless communication with a wireless device. The base station may include a radio, and a processing element operatively coupled to the radio. The base station may be configured to generate control information for transmission to a UE and encode the control information using a first DCI format to produce encoded control information. The first DCI format may specify two or more of 0 bits for format flag, 0 bits for a hopping flag, 4 bits for modulation and coding scheme (MCS) and redundancy version (RV), 0 bits for uplink index, and/or 0 bits for downlink assignment index (DAI). In some embodiments, the first DCI format may specify three or more of 0 bits for format flag, 0 bits for a hopping flag, 4 bits for modulation and coding scheme (MCS) and redundancy version (RV), 0 bits for uplink index, and/or 0 bits for downlink assignment index (DAI). In some embodiments, the first DCI format may further specify 0 bits for carrier indicator, 1 bit for channel state information (CSI) request, 0 bits for sounding reference symbol (SRS) request, and/or 0 bits for resource allocation type. In some embodiments, the first DCI format may specify one or more of a 24 bit length total when using 100 resource blocks, a 23 bit length total when using 75 resource blocks, a 22 bit length total when using 50 resource blocks, a 20 bit length total when using 25 resource blocks, a 18 bit length total when using 15 resource blocks, and/or a 16 bit length total when using 6 resource blocks.

In some embodiments, a base station may be configured to perform wireless communication with a wireless device. The base station may include a radio, and a processing element operatively coupled to the radio. The base station may be configured to generate control information for transmission to a UE and encode the control information using a first DCI format to produce encoded control information. The first DCI format may specify two or more of 0 bits for format flag, 0 bits for localized/distributed indication, 4 bits for modulation and coding scheme (MCS), and/or 0 bits for downlink assignment index (DAI). In some embodiments, the first DCI format may specify one or more of a 25 bit length total when using 100 resource blocks, a 24 bit length total when using 75 resource blocks, a 23 bit length total when using 50 resource blocks, a 21 bit length total when using 25 resource blocks, a 19 bit length total when using 15 resource blocks, and/or a 17 bit length total when using 6 resource blocks.

In some embodiments, a base station may be configured to perform wireless communication with a wireless device. The base station may include a radio, and a processing element operatively coupled to the radio. The base station may be configured to generate control information for transmission to a UE and encode the control information using a first DCI format to produce encoded control information. The first DCI format may specify 0 bits for localized/distributed indication and 4 bits for modulation and coding scheme (MCS). In some embodiments, the first DCI format may specify one or more of a 30 bit length total when using 100 resource blocks, a 29 bit length total when using 75 resource blocks, a 28 bit length total when using 50 resource blocks, a 26 bit length total when using 25 resource blocks, a 24 bit length total when using 15 resource blocks, and/or a 22 bit length total when using 6 resource blocks.

In some embodiments, a base station may be configured to perform wireless communication with a wireless device. The base station may include a radio, and a processing element operatively coupled to the radio. The base station may be configured to generate control information for transmission to a UE and encode the control information using a first DCI format to produce encoded control information. The first DCI format may specify three or more of 0 bits for resource allocation (RA) header, 0 bits for code-word swap, 4 bits for a first modulation and coding scheme (MCS) for a first code-word, 0 bits for a second modulation and coding scheme (MCS) for a second code-word, 0 bits for a new data index (NDI) for the second code-word, 0 bits for a redundancy version (RV) for the second code-word, and/or 0 bits for downlink assignment index (DAI). In some embodiments, the first DCI format may specify one or more of a 41 bit length total when using 25 resource blocks, a 35 bit length total when using 19 resource blocks, a 33 bit length total when using 17 resource blocks, a 31 bit length total when using 13 resource blocks, a 26 bit length total when using 8 resource blocks, and/or a 24 bit length total when using 6 resource blocks.

In some embodiments, a base station may be configured to perform wireless communication with a wireless device. The base station may include a radio, and a processing element operatively coupled to the radio. The base station may be configured to generate control information for transmission to a UE and encode the control information using a first DCI format to produce encoded control information. The first DCI format may specify two or more of a 24 bit length total when using 100 resource blocks, a 23 bit length total when using 75 resource blocks, a 22 bit length total when using 50 resource blocks, a 20 bit length total when using 25 resource blocks, a 18 bit length total when using 15 resource blocks, and/or a 16 bit length total when using 6 resource blocks.

In some embodiments, a base station may be configured to perform wireless communication with a wireless device. The base station may include a radio, and a processing element operatively coupled to the radio. The base station may be configured to generate control information for transmission to a UE and encode the control information using a first DCI format. The first DCI format may be selected from a plurality of possible DCI formats and each of the plurality of possible DCI formats may have a reduced number of bits relative to a current LTE standard.

In some embodiments, a base station may be configured to perform wireless communication with a wireless device. The base station may include a radio, and a processing element operatively coupled to the radio. The base station may be configured to determine a first and a second DCI format for a UE, encode a cellular radio network temporary identifier (C-RNTI) using the first DCI format, send the encoded C-RNTI to the UE, encode a page using the second DCI format, and send the encoded page to the UE.

In some embodiments, a method for providing improved communication performance in a cellular communication system may include a base station performing receiving an indication that a user equipment device (UE) is link budget limited, determining a downlink control information (DCI) format based on the indication, encoding control information using the determined DCI format to produce encoded control information, and sending the encoded control information to the UE. In some embodiments, the determined DCI format may specify two or more of 0 bits for format flag, 0 bits for a hopping flag, 4 bits for modulation and coding scheme (MCS) and redundancy version (RV), 0 bits for uplink index, and/or 0 bits for downlink assignment index (DAI). In some embodiments, the determined DCI format may further specify two or more of 0 bits for carrier indicator, 1 bit for channel state information (CSI) request, 0 bits for sounding reference symbol (SRS) request, and/or 0 bits for resource allocation type. In some embodiments, the determined DCI format may specify two or more of 0 bits for format flag, 0 bits for localized/distributed indication, 4 bits for modulation and coding scheme (MCS), and/or 0 bits for downlink assignment index (DAI). In some embodiments, the determined DCI format may specify 0 bits for localized/distributed indication and 4 bits for modulation and coding scheme (MCS). In some embodiments, the determined DCI format may specify two or more of 0 bits for resource allocation (RA) header, 0 bits for code-word swap, 4 bits for a first modulation and coding scheme (MCS) for a first code-word, 0 bits for a second modulation and coding scheme (MCS) for a second code-word, 0 bits for a new data index (NDI) for the second code-word, 0 bits for a redundancy version (RV) for the second code-word, and/or 0 bits for downlink assignment index (DAI). In some embodiments, the DCI format may specify one or more of a 24 bit length total when using 100 resource blocks, a 23 bit length total when using 75 resource blocks, a 22 bit length total when using 50 resource blocks, a 20 bit length total when using 25 resource blocks, a 18 bit length total when using 15 resource blocks, and/or a 16 bit length total when using 6 resource blocks. In some embodiments, the determined DCI format may specify one or more of
a 25 bit length total when using 100 resource blocks, a 24 bit length total when using 75 resource blocks, a 23 bit length total when using 50 resource blocks, a 21 bit length total when using 25 resource blocks, a 19 bit length total when using 15 resource blocks, and/or a 17 bit length total when using 6 resource blocks. In some embodiments, the determined DCI format may specify one or more of a 30 bit length total when using 100 resource blocks, a 29 bit length total when using 75 resource blocks, a 28 bit length total when using 50 resource blocks, a 26 bit length total when using 25 resource blocks,
a 24 bit length total when using 15 resource blocks, and/or a 22 bit length total when using 6 resource blocks. In some embodiments, the determined DCI format may specify one or more of a 41 bit length total when using 25 resource blocks, a 35 bit length total when using 19 resource blocks, a 33 bit length total when using 17 resource blocks, a 31 bit length total when using 13 resource blocks, a 26 bit length total when using 8 resource blocks, and/or a 24 bit length total when using 6 resource blocks. In some embodiments, determining the DCI format based on the indication may include the base station performing selecting one DCI format from a plurality of possible DCI formats, where the selected DCI format may be a smallest DCI format that supports a determined transmission mode or an equivalent transmission mode. In some embodiments, the determined DCI format may be one of format 0, 1A, 1B, or 2 as specified in as specified in Section 5.3.3.1 of 3GPP TS 36.212 version 10.8.0, and the method may further include the base station performing determining to use an alternative format.

In some embodiments, a user equipment device (UE) may include at least one antenna, at least one radio, and one or more processors coupled to the at least one radio. The at least one radio is configured to perform cellular communication using at least one radio access technology (RAT). Additionally, the one or more processors and the at least one radio are configured to perform voice and/or data communications. The UE may be configured to transmit an indication to a base station that the UE is link budget limited, receive control information encoded in a first downlink control information (DCI) format, and decode the control information according to the first DCI format. The first DCI format may be determined based on the indication. In some embodiments, the first DCI format may specify two or more of 0 bits for format flag, 0 bits for a hopping flag, 4 bits for modulation and coding scheme (MCS) and redundancy version (RV), 0 bits for uplink index, and/or 0 bits for downlink assignment index (DAI). In such embodiments, the first DCI format may be an alternative to DCI format 0 as specified in Section 5.3.3.1.1 of 3GPP TS 36.212 version 10.8.0. In some embodiments, the first DCI format may further specify two or more of 0 bits for carrier indicator, 1 bit for channel state information (CSI) request, 0 bits for sounding reference symbol (SRS) request, and/or 0 bits for resource allocation type. In some embodiments, the first DCI format may specify one or more of a 24 bit length total when using 100 resource blocks, a 23 bit length total when using 75 resource blocks, a 22 bit length total when using 50 resource blocks, a 20 bit length total when using 25 resource blocks, a 18 bit length total when using 15 resource blocks, and/or a 16 bit length total when using 6 resource blocks. IN some embodiments, the first DCI format may specify two or more of 0 bits for format flag, 0 bits for localized/distributed indication, 4 bits for modulation and coding scheme (MCS), and/or 0 bits for downlink assignment index (DAI). In such embodiments, the first DCI format may be an alternative to DCI format 1A as specified in Section 5.3.3.1.3 of 3GPP TS 36.212 version 10.8.0. In some embodiments, the first DCI format may specify one or more of a 25 bit length total when using 100 resource blocks, a 24 bit length total when using 75 resource blocks, a 23 bit length total when using 50 resource blocks, a 21 bit length total when using 25 resource blocks, a 19 bit length total when using 15 resource blocks, and/or a 17 bit length total when using 6 resource blocks. In some embodiments, the first DCI format may specify 0 bits for localized/distributed indication and 4 bits for modulation and coding scheme (MCS). In such embodiments, the first DCI format may be an alternative to DCI format 1B as specified in Section 5.3.3.1.3A of 3GPP TS 36.212 version 10.8.0. In some embodiments, the first DCI format may specify one or more of a 30 bit length total when using 100 resource blocks, a 29 bit length total when using 75 resource blocks, a 28 bit length total when using 50 resource blocks, a 26 bit length total when using 25 resource blocks, a 24 bit length total when using 15 resource blocks, and/or a 22 bit length total when using 6 resource blocks. In some embodiments, the first DCI format may specify two or more of 0 bits for resource allocation (RA) header, 0 bits for code-word swap, 4 bits for a first modulation and coding scheme (MCS) for a first code-word, 0 bits for a second modulation and coding scheme (MCS) for a second code-word, 0 bits for a new data index (NDI) for the second code-word, 0 bits for a redundancy version (RV) for the second code-word, and/or 0 bits for downlink assignment index (DAI). In such embodiments, the first DCI format may be an alternative to DCI format 2 as specified in Section 5.3.3.1.5 of 3GPP TS 36.212 version 10.8.0. In some embodiments, the first DCI format may specify a 41 bit length total when using 25 resource blocks, a 35 bit length total when using 19 resource blocks, a 33 bit length total when using 17 resource blocks, a 31 bit length total when using 13 resource blocks, a 26 bit length total when using 8 resource blocks, and/or
a 24 bit length total when using 6 resource blocks.

In some embodiments, a user equipment device (UE) may include at least one antenna, at least one radio, and one or more processors coupled to the at least one radio. The at least one radio is configured to perform cellular communication using at least one radio access technology (RAT). Additionally, the one or more processors and the at least one radio are configured to perform voice and/or data communications. The UE may be configured to transmit an indication to a base station that the UE is link budget limited, receive control information encoded in a first downlink control information (DCI) format, and decode the control information according to the first DCI format. The first DCI format may be determined based on the indication. In some embodiments, the first DCI format may specify two or more of 0 bits for format flag, 0 bits for a hopping flag, 4 bits for modulation and coding scheme (MCS) and redundancy version (RV), 0 bits for uplink index, and/or 0 bits for downlink assignment index (DAI). In some embodiments, the first DCI format may further specify 0 bits for carrier indicator, 1 bit for channel state information (CSI) request, 0 bits for sounding reference symbol (SRS) request, and/or 0 bits for resource allocation type. In some embodiments, the first DCI format may specify one or more of a 24 bit length total when using 100 resource blocks, a 23 bit length total when using 75 resource blocks, a 22 bit length total when using 50 resource blocks, a 20 bit length total when using 25 resource blocks, a 18 bit length total when using 15 resource blocks, and/or a 16 bit length total when using 6 resource blocks.

In some embodiments, a user equipment device (UE) may include at least one antenna, at least one radio, and one or more processors coupled to the at least one radio. The at least one radio is configured to perform cellular communication using at least one radio access technology (RAT). Additionally, the one or more processors and the at least one radio are configured to perform voice and/or data communications. The UE may be configured to transmit an indication to a base station that the UE is link budget limited, receive control information encoded in a first downlink control information (DCI) format, and decode the control information according to the first DCI format. The first DCI format may be determined based on the indication. In some embodiments, the first DCI format may specify two or more of 0 bits for format flag, 0 bits for localized / distributed indication, 4 bits for modulation and coding scheme (MCS), and/or 0 bits for downlink assignment index (DAI). In some embodiments, the first DCI format may specify one or more of a 25 bit length total when using 100 resource blocks, a 24 bit length total when using 75 resource blocks, a 23 bit length total when using 50 resource blocks, a 21 bit length total when using 25 resource blocks, a 19 bit length total when using 15 resource blocks, and/or a 17 bit length total when using 6 resource blocks.

In some embodiments, a user equipment device (UE) may include at least one antenna, at least one radio, and one or more processors coupled to the at least one radio. The at least one radio is configured to perform cellular communication using at least one radio access technology (RAT). Additionally, the one or more processors and the at least one radio are configured to perform voice and/or data communications. The UE may be configured to transmit an indication to a base station that the UE is link budget limited, receive control information encoded in a first downlink control information (DCI) format, and decode the control information according to the first DCI format. The first DCI format may be determined based on the indication. In some embodiments, the first DCI format may specify 0 bits for localized/distributed indication and 4 bits for modulation and coding scheme (MCS). In some embodiments the first DCI format may specify a 30 bit length total when using 100 resource blocks, a 29 bit length total when using 75 resource blocks, a 28 bit length total when using 50 resource blocks, a 26 bit length total when using 25 resource blocks, a 24 bit length total when using 15 resource blocks, and/or a 22 bit length total when using 6 resource blocks.

In some embodiments, a user equipment device (UE) may include at least one antenna, at least one radio, and one or more processors coupled to the at least one radio. The at least one radio is configured to perform cellular communication using at least one radio access technology (RAT). Additionally, the one or more processors and the at least one radio are configured to perform voice and/or data communications. The UE may be configured to transmit an indication to a base station that the UE is link budget limited, receive control information encoded in a first downlink control information (DCI) format, and decode the control information according to the first DCI format. The first DCI format may be determined based on the indication. In some embodiments, the first DCI format may specify three or more of 0 bits for resource allocation (RA) header, 0 bits for code-word swap, 4 bits for a first modulation and coding scheme (MCS) for a first code-word, 0 bits for a second modulation and coding scheme (MCS) for a second code-word, 0 bits for a new data index (NDI) for the second code-word, 0 bits for a redundancy version (RV) for the second code-word, and/or 0 bits for downlink assignment index (DAI). In some embodiments, the first DCI format may specify one or more of a 41 bit length total when using 25 resource blocks, a 35 bit length total when using 19 resource blocks, a 33 bit length total when using 17 resource blocks, a 31 bit length total when using 13 resource blocks, a 26 bit length total when using 8 resource blocks, and/or a 24 bit length total when using 6 resource blocks.

In some embodiments, a user equipment device (UE) may include at least one antenna, at least one radio, and one or more processors coupled to the at least one radio. The at least one radio is configured to perform cellular communication using at least one radio access technology (RAT). Additionally, the one or more processors and the at least one radio are configured to perform voice and/or data communications. The UE may be configured to receive a cell radio network temporary identifier (C-RNTI) encoded in a first downlink control information (DCI) format, decode the C-RNTI using the first DCI format, receive a page encoded in a second DCI format, and decode the page using the second DCI format.

In some embodiments, a user equipment device (UE) may include at least one antenna, at least one radio, and one or more processors coupled to the at least one radio. The at least one radio is configured to perform cellular communication using at least one radio access technology (RAT). Additionally, the one or more processors and the at least one radio are configured to perform voice and/or data communications. The UE may be configured to receive encoded control information from a base station, where the encoded control information was encoded using a first DCI format, and decode the encoded control information using the first DCI format. The first DCI format may be selected from a plurality of possible DCI formats and each of the plurality of possible DCI formats may have a reduced number of bits relative to a current LTE standard.

Embodiments of the present disclosure may be realized in any of various forms. For example some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement a method, e.g., any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A base station configured to perform wireless communication with a wireless device, the base station comprising:
a radio; and
a processing element operatively coupled to the radio;
wherein the base station is configured to:
receive an indication that a user equipment device (UE) is link budget limited;
determine a downlink control information (DCI) format based on the indication;
encode control information using the determined DCI format, thereby producing encoded control information; and
send the encoded control information to the UE.

2. The base station of claim 1, wherein the determined DCI format specifies two or more of:
0 bits for format flag;
0 bits for a hopping flag;
4 bits for modulation and coding scheme (MCS) and redundancy version (RV);
0 bits for uplink index; or
0 bits for downlink assignment index (DAI).

3. The base station of claim 2,
wherein the determined DCI format is an alternative to DCI format 0 as specified in Section 5.3.3.1.1 of 3GPP TS 36.212 version 10.8.0.

4. The base station of claim 2,
wherein the determined DCI format further specifies two or more of:
0 bits for carrier indicator;
1 bit for channel state information (CSI) request;
0 bits for sounding reference symbol (SRS) request; or
0 bits for resource allocation type.

5. The base station of claim 1,
wherein the determined DCI format specifies one or more of:
a 24 bit length total when using 100 resource blocks;
a 23 bit length total when using 75 resource blocks;
a 22 bit length total when using 50 resource blocks;
a 20 bit length total when using 25 resource blocks;
a 18 bit length total when using 15 resource blocks; or
a 16 bit length total when using 6 resource blocks.

6. The base station of claim 1, wherein the determined DCI format specifies two or more of:
0 bits for format flag;
0 bits for localized/distributed indication;
4 bits for modulation and coding scheme (MCS); or
0 bits for downlink assignment index (DAI).

7. The base station of claim 6,
wherein the determined DCI format is an alternative to DCI format 1A as specified in Section 5.3.3.1.3 of 3GPP TS 36.212 version 10.8.0.

8. The base station of claim 1,
wherein the determined DCI format specifies one or more of:
a 25 bit length total when using 100 resource blocks;
a 24 bit length total when using 75 resource blocks;
a 23 bit length total when using 50 resource blocks;
a 21 bit length total when using 25 resource blocks;
a 19 bit length total when using 15 resource blocks; or
a 17 bit length total when using 6 resource blocks.

9. The base station of claim 1,
wherein the determined DCI format specifies:
0 bits for localized/distributed indication; and
4 bits for modulation and coding scheme (MCS).

10. The base station of claim 9,
wherein the determined DCI format is an alternative to DCI format 1B as specified in Section 5.3.3.1.3A of 3GPP TS 36.212 version 10.8.0.

11. The base station of claim 1,
wherein the determined DCI format specifies one or more of:
a 30 bit length total when using 100 resource blocks;
a 29 bit length total when using 75 resource blocks;
a 28 bit length total when using 50 resource blocks;
a 26 bit length total when using 25 resource blocks;
a 24 bit length total when using 15 resource blocks; or
a 22 bit length total when using 6 resource blocks.

12. The base station of claim 1,
wherein the determined DCI format specifies two or more of:
0 bits for resource allocation (RA) header;
0 bits for code-word swap;
4 bits for a first modulation and coding scheme (MCS) for a first code-word;
0 bits for a second modulation and coding scheme (MCS) for a second code-word;
0 bits for a new data index (NDI) for the second code-word;
0 bits for a redundancy version (RV) for the second code-word; or
0 bits for downlink assignment index (DAI).

13. The base station of claim 12,
wherein the determined DCI format is an alternative to DCI format 2 as specified in Section 5.3.3.1.5 of 3GPP TS 36.212 version 10.8.0.

14. The base station of claim 1,
wherein the determined DCI format specifies one or more of:
a 41 bit length total when using 25 resource blocks;
a 35 bit length total when using 19 resource blocks;
a 33 bit length total when using 17 resource blocks;
a 31 bit length total when using 13 resource blocks;
a 26 bit length total when using 8 resource blocks; or
a 24 bit length total when using 6 resource blocks.

15. The base station of claim 1,
wherein, in determining the downlink control information (DCI) format based on the indication, the base station is configured to select one DCI format from a plurality of possible DCI formats;
wherein the base station is configured to select a smallest DCI format that supports a determined transmission mode or an equivalent transmission mode.

16. A method for providing improved communication performance in a cellular communication system, the method comprising:
performing, by a base station:
receiving an indication that a user equipment device (UE) is link budget limited;
determining a downlink control information (DCI) format based on the indication;
encoding control information using the determined DCI format, thereby producing encoded control information; and
sending the encoded control information to the UE.

17. The method of claim 16,
wherein the first DCI format is an alternative to at least one of:
DCI format 0 as specified in Section 5.3.3.1.1 of 3GPP TS 36.212 version 10.8.0;
DCI format 1A as specified in Section 5.3.3.1.3 of 3GPP TS 36.212 version 10.8.0;
DCI format 1B as specified in Section 5.3.3.1.3A of 3GPP TS 36.212 version 10.8.0; or
DCI format 2 as specified in Section 5.3.3.1.5 of 3GPP TS 36.212 version 10.8.0.

18. The method of claim 16,
wherein, said determining the downlink control information (DCI) format based on the indication comprises the base station selecting one DCI format from a plurality of possible DCI formats, wherein the selected DCI format is a smallest DCI format that supports a determined transmission mode or an equivalent transmission mode.

19. A user equipment device (UE), comprising:
at least one antenna;
at least one radio, wherein the at least one radio is configured to perform cellular communication using at least one radio access technology (RAT);
one or more processors coupled to the at least one radio, wherein the one or more processors and the at least one radio are configured to perform voice and/or data communications;
wherein the UE is configured to:
transmit an indication to a base station that the UE is link budget limited;
receive control information encoded in a first downlink control information (DCI) format, wherein the first DCI format is determined based on the indication; and
decode the control information according to the first DCI format.

20. The UE of claim 19,
wherein the first DCI format is an alternative to at least one of:
DCI format 0 as specified in Section 5.3.3.1.1 of 3GPP TS 36.212 version 10.8.0;
DCI format 1A as specified in Section 5.3.3.1.3 of 3GPP TS 36.212 version 10.8.0;
DCI format 1B as specified in Section 5.3.3.1.3A of 3GPP TS 36.212 version 10.8.0; or
DCI format 2 as specified in Section 5.3.3.1.5 of 3GPP TS 36.212 version 10.8.0.
